(19) United States
(12) Patent Application Publication
(10) Pub. No.: US 2015/0178811 A1
(43) Pub. Date: Jun. 25, 2015

(54) SYSTEM AND METHOD FOR RECOMMENDING SERVICE OPPORTUNITIES

(71) Applicant: Google Inc., (US)

(72) Inventor: Shuohui Chen, Fremont, CA (US)

(73) Assignee: Google Inc., Mountain View, CA (US)

(21) Appl. No.: 13/773,314

(22) Filed: Feb. 21, 2013

(51) Int. Cl. G06Q 30/06

(52) U.S. Cl. CPC G06Q 30/0631

(57) ABSTRACT

Systems, methods, and computer-readable storage media that may be used to recommend service opportunities are provided. One method includes receiving input data relating to a plurality of service options for one or more services provided to a customer using a communications network. The method further includes, for each of the plurality of service options, calculating an estimated likelihood of adoption, an expected revenue increase, and an opportunity score for the service option based on the estimated likelihood of adoption and the expected revenue increase. The method further includes selecting one or more of the service options to be recommended to a user based on the opportunity scores of the plurality of service options. The method further includes providing the user with information relating to the one or more selected service options.

### BACKGROUND

Online content management systems allow content publishers to publish content that promotes the content publisher and/or products/services that the content publisher sells. Customer service representatives may assist content publishers in determining publication opportunities that they may wish to pursue within limited publication budgets. Recommendation systems may be used to assist customer service representatives in marketing online service opportunities, such as online content publication opportunities, to customers interested in such services. Unlike selling more statically defined products where the price has been determined and the opportunities can be directly ranked based on revenue/profit and likelihood of sales success, marketing online services presents unique challenges in attempting to rank and/or classify service opportunities.

### SUMMARY

One implementation of the disclosure relates to a method that includes receiving, at a computerized recommendation system, input data relating to a plurality of service options for one or more services provided to a customer using a communications network. The method further includes, for each of the plurality of service options, calculating, at the recommendation system, an estimated likelihood of adoption, an expected revenue increase, and an opportunity score for the service option based on the estimated likelihood of adoption and the expected revenue increase. The estimated likelihood of adoption is an estimate of the probability that the customer will adopt the service option. The expected revenue increase is an estimated increase in revenue for the customer that is expected to result from the customer adopting the service option. The method further includes selecting, at the recommendation system, one or more of the service options to be recommended to a user based on the opportunity scores of the plurality of service options. The method further includes providing the user with information relating to the one or more selected service options.

Another implementation of the disclosure relates to a system including at least one computing device operably coupled to at least one memory and configured to receive input data relating to a plurality of service options for one or more services provided to a customer using a communications network. The at least one computing device is further configured to, for each of the plurality of service options, calculate an estimated likelihood of adoption, an expected revenue increase, and an opportunity score for the service option based on the estimated likelihood of adoption and the expected revenue increase. The estimated likelihood of adoption is an estimate of the probability that the customer will adopt the service option. The expected revenue increase is an estimated increase in revenue for the customer that is expected to result from the customer adopting the service option. The at least one computing device is further configured to select one or more of the service options to be recommended to a user based on the opportunity scores of the plurality of service options and to provide the user with information relating to the one or more selected service options.

Another implementation of the disclosure relates to a computer-readable storage medium having instructions stored thereon that, when executed by a processor, cause the processor to perform operations including receiving input data relating to a plurality of service options for one or more services provided to a customer using a communications network. The operations further include, for each of the plurality of service options, calculating an estimated likelihood of adoption, an expected revenue increase, and an opportunity score for the service option based on the estimated likelihood of adoption and the expected revenue increase. The estimated likelihood of adoption is an estimate of the probability that the customer will adopt the service option. The expected revenue increase is an estimated increase in revenue for the customer that is expected to result from the customer adopting the service option. The operations further include selecting one or more of the service options to be recommended to a user based on the opportunity scores of the plurality of service options and providing the user with information relating to the one or more selected service options.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is a block diagram of a content management system and associated environment according to an illustrative implementation.

FIG. 2 is a flow diagram of a process for providing service opportunity recommendations according to an illustrative implementation.

FIG. 3A is a flow diagram of a process for generating a model that may be used to estimate a likelihood of marketing/adoption according to an illustrative implementation.

FIG. 3B is a receiver operating characteristic (ROC) curve illustrating the performance of an example model generated according to the process shown in FIG. 3A in comparison to other example models according to an illustrative implementation.

FIG. 3C is a ROC curve illustrating overfitting under the example model generated according to the process shown in FIG. 3A in comparison to other example models according to an illustrative implementation.

FIG. 4A is a flow diagram of a process for generating a model that may be used to predict revenue uplifts according to an illustrative implementation.

FIG. 4B is a ROC curve illustrating the performance of an example model generated according to the process shown in FIG. 4A according to an illustrative implementation.

FIG. 4C is a cumulative gains chart illustrating the performance of the example model generated according to the process shown in FIG. 4A according to an illustrative implementation.

FIG. 5 is a flow diagram of a more detailed implementation of the process shown in FIG. 2 according to an illustrative implementation.

FIG. 6 is a display image of an example output interface that may be displayed to a user by the content management system according to an illustrative implementation.

FIG. 7 is an example headcount chart that may be used in preparing an experiment to test performance of the processes shown in FIGS. 2 and/or 5 according to an illustrative implementation.

FIG. 8 is a block diagram of a computing device according to an illustrative implementation.

### DETAILED DESCRIPTION

Referring generally to the Figures, various illustrative systems and methods are provided that generate recommendations for online service opportunities that customers may wish to pursue, such as online content publication opportunities. Unlike selling more statically defined products where the price has been determined and the opportunities can be directly ranked based on revenue/profit and likelihood of sales success, marketing online services presents some unique challenges. For example, it is difficult to accurately estimate and explain the opportunity values associated with some online services based on predicted revenue uplifts and adoption likelihoods. Additionally, it may be challenging to rank and optimize opportunities based on a customer's business requirements and to package the opportunities in a manner that is useful for recommending to the customer as solutions to the customer's business problems.

A content management system according to illustrative implementations of the present disclosure is configured to generate recommendations based on both an estimated likelihood of adoption of a recommended opportunity by the customer and an expected revenue uplift for the customer resulting from a recommendation being adopted. In some implementations, the system may be utilized by customer service representatives to assist with marketing potential opportunities to customers. In some implementations, the system may be used directly by the customers themselves to explore potential opportunities. A final opportunity value may be generated based on the likelihood of adoption, expected revenue uplift, and/or likelihood of marketing estimates and used to rank opportunities. In some implementations, the final opportunity value may be defined as (likelihood that customer service representative will pitch opportunity)*(likelihood that customer will adopt opportunity)*(expected revenue/profit uplift for customer if customer adopts opportunity). The likelihood of marketing, likelihood of adoption, and/or predicted revenue uplift may be estimated using a logistic regression model, random forest model, or another type of model. In some implementations, users may be permitted to specify parameters and/or business requirements to be used in determining recommended opportunities, such as requiring that the customer's expected return on investment (“ROI”) (e.g., click through rate) not be reduced by adopting an opportunity or providing only three recommended opportunities to the customer. The system may be configured to convert the output signals and/or filters from the statistical predictive models into notes that can be easily interpreted by the users (e.g., by customer service representatives to recommend opportunities to their customers or by the customers themselves to determine which opportunities to pursue).

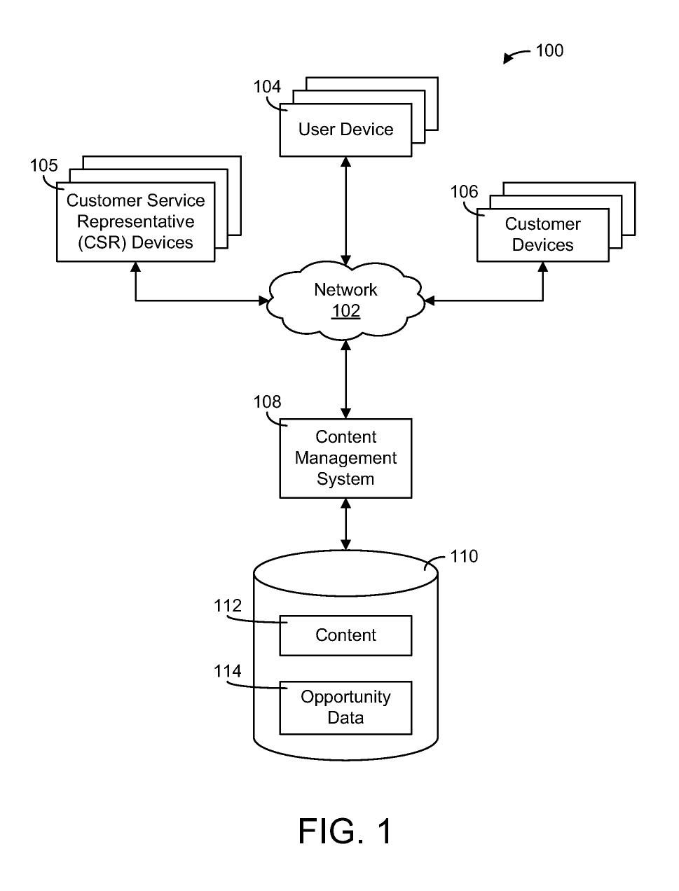

Referring now to FIG. 1, and in brief overview, a block diagram of a content management system 108 and associated environment 100 is shown according to an illustrative implementation. One or more user devices 104 may be used by a user to perform various actions and/or access various types of content, some of which may be provided over a network 102 (e.g., the Internet, LAN, WAN, etc.). For example, user devices 104 may be used to access websites (e.g., using an internet browser), media files, and/or any other types of content. Content management system 108 may be configured to select content for display to users within resources (e.g., webpages, applications, etc.) and to provide content from a content database 110 to user devices 104 over network 102 for display within the resources. The content from which content management system 108 selects items may be provided by one or more content providers via network 102 using content provider devices 106.

In some implementations, bids for content to be selected by content management system 108 may be provided to content management system 108 from content publishers participating in an auction using devices, such as content provider devices 106, configured to communicate with content management system 108 through network 102. In such implementations, content management system 108 may determine content to be published based at least in part on the bids.

Content management system 108 is configured to provide recommendations for different content publication opportunities or options that a content publisher may wish to consider. For example, content management system 108 may recommend that a content publisher adjust settings (e.g., bid settings) associated with a campaign to increase a number of impressions of certain content published in a certain resource, at a certain time, upon occurrence of certain conditions, etc. In another example, content management system 108 may recommend that a content publisher try publishing content under a different type of content publication product. For example, content management system 108 may recommend that a content publisher that publishes content primarily in relation to an online search engine try bidding to publish content in relation to a mobile application or other mobile resource. In some implementations, content management system 108 may provide the recommendations directly to a content provider. In some implementations, content management system 108 may provide the recommendations to a customer service representative who assists one or more content providers in making decisions regarding content publication campaigns.

Referring still to FIG. 1, and in greater detail, user devices 104, customer service representative (CSR) devices 105, and/or content provider devices 106 may be any type of computing device (e.g., having a processor and memory or other type of computer-readable medium), such as a television and/or set-top box, mobile communication device (e.g., cellular telephone, smartphone, etc.), computer and/or media device (desktop computer, laptop or notebook computer, netbook computer, tablet device, gaming system, etc.), or any other type of computing device. In some implementations, one or more user devices 104 may be set-top boxes or other devices for use with a television set. In some implementations, content may be provided via a web-based application and/or an application resident on a user device 104. In some implementations, user devices 104, CSR devices 105, and/or content provider devices 106 may be designed to use various types of software and/or operating systems. In various illustrative implementations, user devices 104, CSR devices 105, and/or content provider devices 106 may be equipped with and/or associated with one or more user input devices (e.g., keyboard, mouse, remote control, touchscreen, etc.) and/or one or more display devices (e.g., television, monitor, CRT, plasma, LCD, LED, touchscreen, etc.).

User devices 104, CSR devices 105, and/or content provider devices 106 may be configured to receive data from various sources using a network 102. In some implementations, network 102 may comprise a computing network (e.g., LAN, WAN, Internet, etc.) to which user devices 104, CSR devices 105, and/or content provider devices 106 may be connected via any type of network connection (e.g., wired, such as Ethernet, phone line, power line, etc., or wireless, such as WiFi, WiMAX, 3G, 4G, satellite, etc.). In some implementations, network 102 may include a media distribution network, such as cable (e.g., coaxial metal cable), satellite, fiber optic, etc., configured to distribute media programming and/or data content.

Some content that may be accessed via user devices 104 may include content that has been selected to appear in conjunction with certain resources through an auction or other content selection process. For example, a portion of a search result interface or another resource may be configured to display content that has been selected through the use of an auction. Content management system 108 may be configured to receive bids from auction participants (e.g., content providers) and select content to be displayed in resources (e.g., on webpages) based on the bids. In some implementations, content may be ranked based on bids associated with the content. A search engine or other resource operator may receive revenue by auctioning a certain set of keywords to auction participants. Auction participants may place auction bids for the ability to include their content on the search result resource, whenever a user searches using a keyword in the set. For example, an online manufacturer of golf equipment may participate in an auction for the golf-related set of keywords. If a user searches for the term “golf,” and the manufacturer is determined to be the winner of the auction, content from the manufacturer may appear in the same resource as the search results. A provider of a website devoted to a particular topic may also receive revenue by auctioning off the ability to place content with his or her resource (e.g., embedded in a webpage, in a pop-up window, etc.). In some implementations, the provider of the website may be a different entity than the provider of content management system 108. Similar to bidding on search results, an auction participant may place a bid in the auction using a set of keywords that corresponds to keywords found in the text of the resource. In some implementations, the auction bids may additionally or alternatively include criteria other than keywords, such as user interests, locations (e.g., geographic areas), semantic entities of resources (e.g., web pages), etc.

In some implementations, a content provider may create an account with content management system 108. Associated with the account may be data relating to which content the content provider wishes to use, a daily budget to spend, topical categories of resources on which the content is to be placed (e.g., resources related to Sports>Golf, etc.), one or more bid amounts, and/or other data (e.g., statistical data) that may be used by content management system 108 to select content to be displayed by user devices 104. When a user device 104 interacts with a resource that participates in the auction network, content management system 108 may compare bids among auction participants to select content to be included in the resource. In some implementations, bids may be received from one or more content provider devices 106, and information relating to the bids, including the content associated with the bids, may be stored in content database 110 (e.g., in a content portion 112).

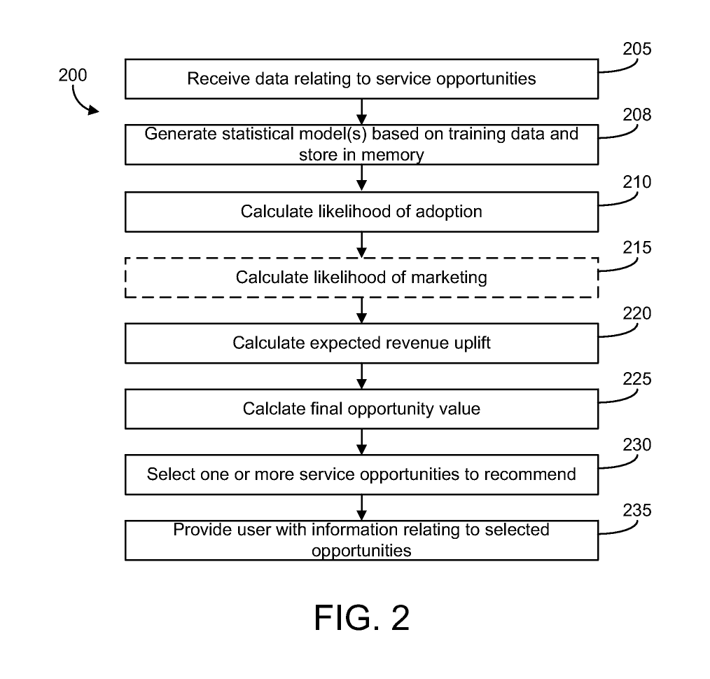

Content management system 108 is configured to provide recommendations to users (e.g., customer service representatives marketing opportunities to customers or directly to the customers themselves) for content publication opportunities that may be of interest to the users. FIG. 2 illustrates a flow diagram of a process 300 for providing recommendations for service opportunities according to an illustrative implementation. Referring to both FIGS. 1 and 2, content management system 108 may receive data relating to one or more opportunities that a customer may be interested in pursuing (205). The opportunities may include increasing a number or amount of bids for displaying content within a particular resource or content publication product, bidding or registering to display content in relation to a resource or content publication product with which the content publisher has not been previously associated or has not been associated for a certain amount of time, or any other service or feature that may be sold to content publishers to generate revenue for an opportunity seller. In some implementations, data relating to the opportunities may be stored in an opportunity data portion 114 of database 110.

The input data may include one or more of a variety of types of data relating to the customer for whom the analysis is being performed and the opportunities available for the customer to consider. The input data may include data received from a user of the system that is used to determine opportunities to analyze. For example, a user may enter an account identifier for the customer being analyzed that system 108 may use to obtain information regarding the content publication services and features that the customer is currently utilizing. The account identifier may be used to obtain data such as a current budget, revenue associated with the services currently being utilized, total bid amount, performance statistics (e.g., number of impressions, click through rate, quality statistics, etc.), number and type of content groups in which bids were submitted, number and type of keywords for which bids were submitted, etc. In various illustrative implementations, a wide variety of different input data signals may be utilized to determine opportunity recommendations to present to the user, such as recency and/or frequency of the content provider logging in to system 108, history of the content provider adopting/using certain products/features of system 108 (e.g., desktop device/content device/conversion reporting, has content extension/sitelink extension/video content/location extension/mobile or tablet/enhanced cost per click/conversion optimizer, etc.), content competitiveness metrics (e.g., impression shares, throttled impression shares, bid lost impression shares, number/percent of content groups having relative click through rate, etc.).

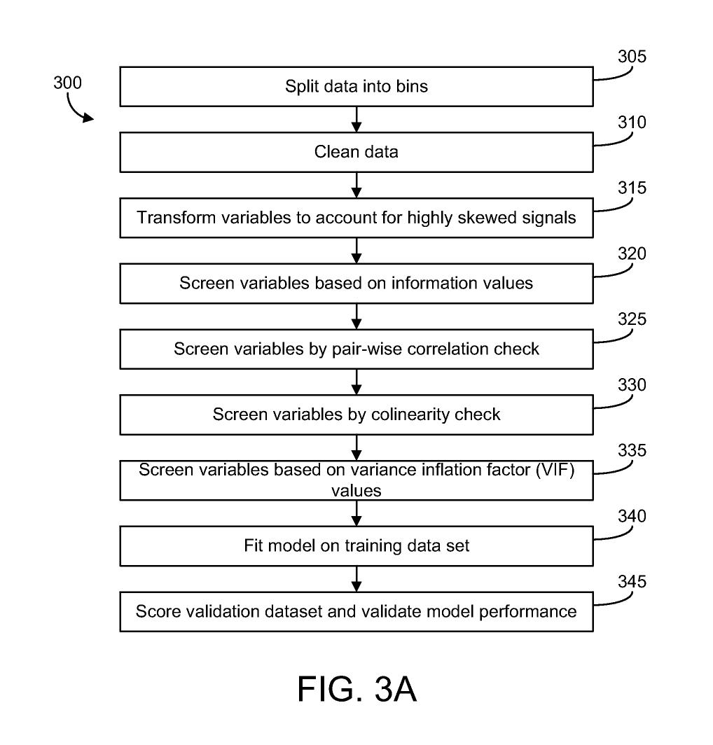

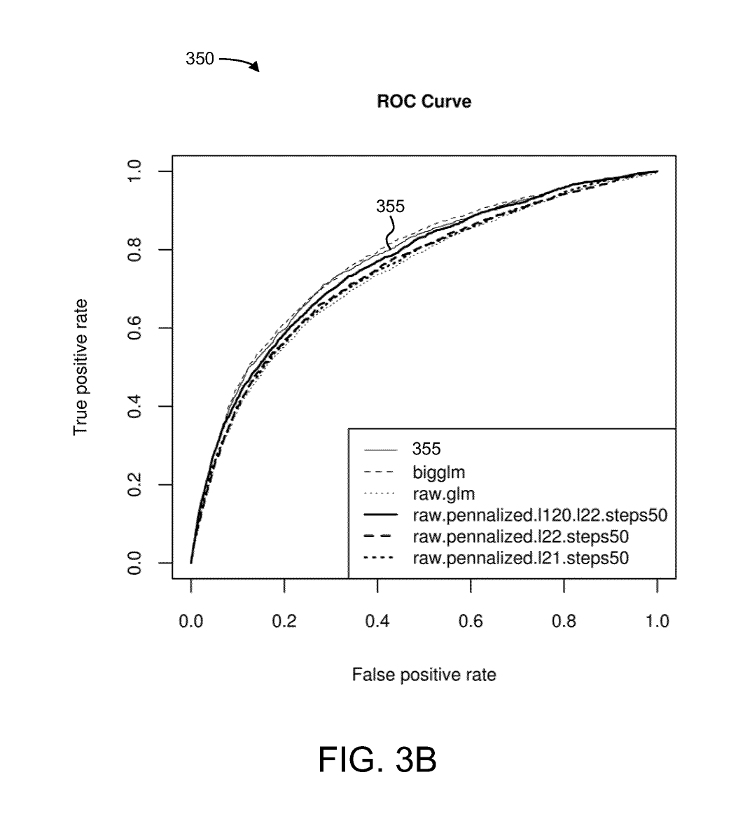

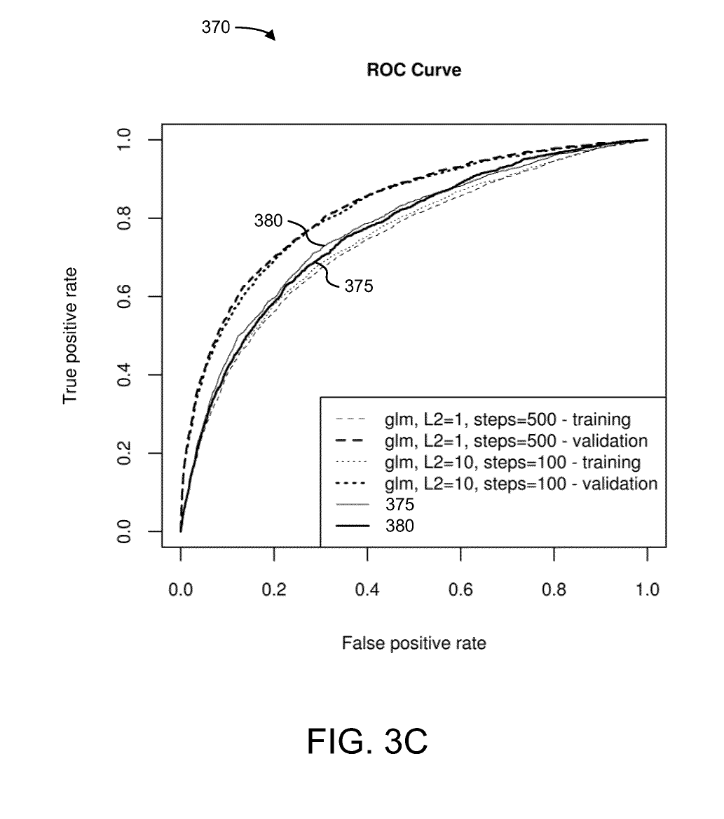

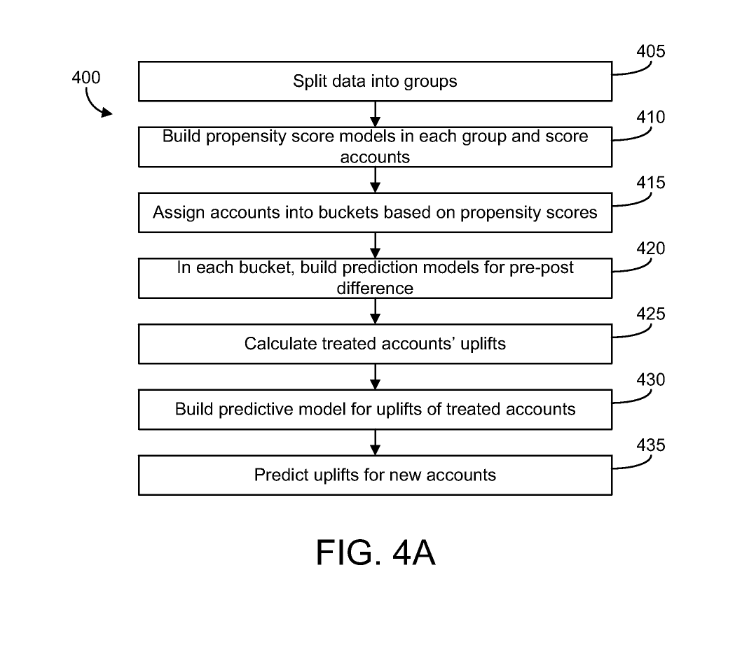

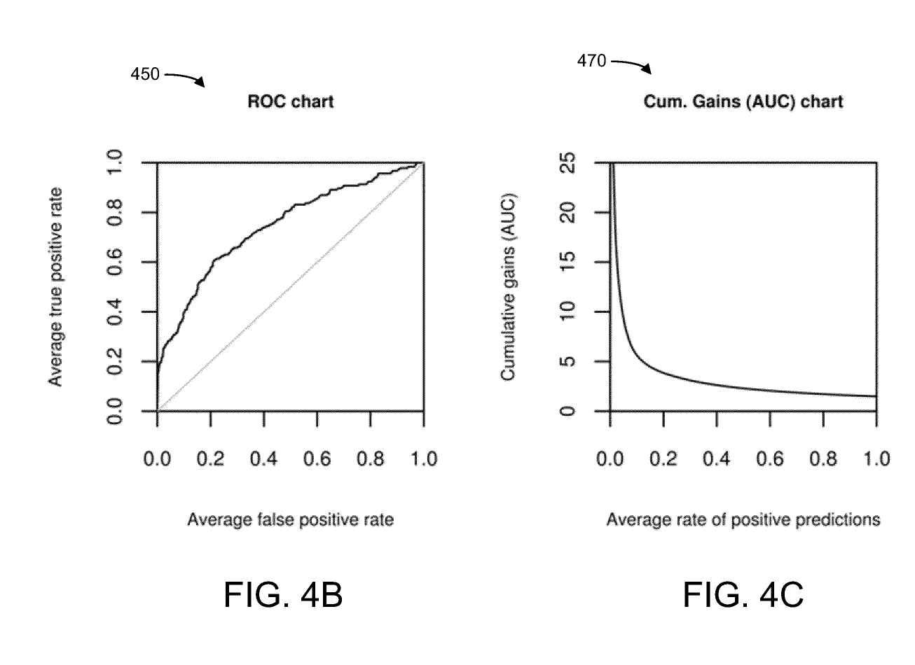

Content management system 108 may be configured to generate one or more statistical models based on training data and stored the statistical models in a memory, such as content database 110. Illustrative processes that may be used to generate the one or more statistical models are described in further detail below (e.g., with respect to FIGS. 3A and 4A).

Content management system 108 may be configured to calculate a likelihood of adoption for each of the opportunities being analyzed for the user based on one or more of the statistical models (210). The likelihood of adoption may include a value or score (e.g., a percentage) that represents an estimated likelihood that a customer, if presented with the opportunity, would adopt or move forward with the opportunity. At least a portion of the received input data may be processed by a likelihood of adoption model to calculate the likelihood of adoption value. In various implementations, the model may be or include a logistic regression model, a random forest model, or another type of model configured to estimate the likelihood that the customer will adopt an opportunity. The model may utilize various types of input to estimate the likelihood of adoption, such as previous bids/purchases made by the customer, adoption history (e.g., decisions (adoption or rejection) the customer made with respect to previously proposed opportunities), budget, data regarding the products, features, options, etc. that the customer is currently using or has used in the past, and/or other types of inputs that may be relevant to whether the customer is likely to adopt the opportunities being analyzed. The some implementations, the input may include, for example, one or more of the recency and/or frequency of the content provider logging in to system 108, history of the content provider adopting/using certain products/features of system 108 (e.g., conversion tracking, content extension, sitelink extension, video content, location extension, mobile or tablet, enhanced cost per click, conversion optimizer, etc.), content competitiveness metrics (e.g., impression shares, number/percent of content groups having relative click through rate, etc.), budget amount and utilization, average bid amount, performance statistics (e.g., number of impressions, click through rate, quality statistics, etc.), content provider trajectories (e.g., month or month spend growth, month over month cost per click, month or month click through rate, etc.), distribution over content types (e.g., percent of total content publication spend on display/mobile/search/video, etc.), number and type of content groups in which bids were submitted, number and type of keywords for which bids were submitted, number and status of campaigns in which bids were submitted, etc.

FIG. 3A illustrates a flow diagram of a process 300 that may be used to generate a model for use in calculating the estimated likelihood of adoption according to an illustrative implementation. Process 300 implements a training stage that utilizes a training data set to build a model that is configured to receive a variety of types of input signals and calculate the likelihood of adoption based on the input signals. In some implementations, the training data may include up to 100,000 rows of training data and hundreds or even thousands of candidate signals (e.g., binary signals). The training data may be data where the outcome of a presented opportunity (e.g., whether or not the customer adopted the opportunity) is known, such as data regarding opportunities presented to the customer or customers sharing similarities with the customer in the past. While the disclosure below discusses input data in a row and column format, data in other formats may be utilized in other implementations.

System 108 may be configured to receive the training data set and split the data into bins according to a binning transformation (305). System 108 may trim any rows (records) that have too many missing values (e.g., greater than 30% of total columns missing). For the remaining data, for columns having greater than a threshold amount of missing values (e.g., 5% missing values), the columns may be split into separate bins. In some implementations, the columns having the missing data may be split into quantiles (4 bins) by default. Missing values may be placed in a separate bin for each column and may be treated as a separate level in a manner similar to the corresponding variable's other bins. The start and end values of each bin may be saved in configuration files and used for subsequent binning transformations. For example, after the training has been completed and the model has been generated, at a scoring stage in which new data is received for the purposes of computing a likelihood of adoption of opportunities for customers, the same binning transformation applied at the training stage using the training data may be applied at the scoring stage to prepare the new data for scoring (e.g., the new data may be split into bins according to the start and end values of each bin stored in the configuration files).

Once the data has been placed into bins, the data may be cleaned (310). Missing and/or extreme values or values that are not applicable to the likelihood of adoption analysis may be removed or replaced (e.g., with a default value, such as an average value for the bin). Singular columns that contain singular dominant values may be excluded. In some implementations, dummy variables may be created to replace categorical variables. Categorical variables are variables that can take on one of a limited (e.g., fixed) number of possible values. Dummy variables take on a binary value (e.g., 0 or 1) to indicate the absence or presence of some categorical effect that may be expected to shift the outcome. For example, if a variable “sales market” can take on values among three possible values “US”, “UK”, “FR”, it can be treated as a category variable. Three dummy variables, US, UK, and FR, may be used to replace the categorical variable. In modeling the adoption likelihood through regressions or machine learning models, dummization of a categorical variable may help significantly speed up the convergence of the algorithm when the training dataset is large.

System 108 may apply a transformation to the variables to account for any highly skewed signals (315). During the training stage, highly skewed signals may be identified (e.g., by comparison to other values, such as an average value) and transformed to keep the values from unduly affecting the generated model. In some implementations, a normalization or logarithmic transformation may be applied to the highly skewed signals. The transformations applied to the highly skewed signals may be saved into configuration files for application to subsequent transformations. At the scoring stage, the transformations stored in the configuration files may be applied to the new data to keep any skewed signals in the new data from unduly affecting the computed likelihood of adoption value.

Once the data has cleaned and transformed into a useful format, the variables may be screened to prune the variables in the training data set to those variables that will be most effective in predicting the likelihood of adoption. System 108 may screen the variables based on information values (320). Information values are used to measure the overall predictability of a variable for a binary response. Low IV values suggest low predictability. Information values have been used in relation to credit score models. In some implementations, information values for each bin may be defined as follows:

IVᵢ=sum[WOEᵢ*(% of adoptions in bin i−% of non-adoptions in bin i)]

where
WOEᵢ (weight of evidence of bin i)=log(% of adoptions in bin i)−log(% of non-adoptions in bin i)

and i=1, 2, 3, . . . , number of bins

In some implementations, variables may be ranked or organized according to their IV values and a maximum and/or minimum number of variables (e.g., number of columns) may be enforced to filter out low predictive variables. For example, only a threshold amount of variables having the highest information values may be retained for purposes of building the model. In some implementations, only variables having information values above a certain threshold value (e.g., 0.1) may be retained. In this manner, system 108 may be capable of handling variable selection for a relatively large number (e.g., thousands) of variables (e.g., columns).

System 108 may be configured to screen the variables based on a pair-wise correlation check (325). The remaining columns may be ranked in order according to their information values. The pair-wise correlation (e.g., Pearson correlation coefficient) of the top two columns may be checked (except for the column of response). If the correlation between the columns is greater than a threshold value (e.g., 0.4), then the column with the lower information value may be dropped. A high correlation coefficient indicates that the variables will react similarly to the same input signals, and removing one of the highly correlated variables may help prevent those particular types of variables from unduly influencing the model. In some implementations, both columns may be retained if they have a pscore above a certain threshold (e.g., 0.1).

System 108 may screen the variables using a colinearity check between the variables and the response (330). The correlation coefficients (e.g., Pearson correlation coefficients) between the response column and each individual column may be checked. Any columns for which the correlation coefficient with the response exceeds a threshold value (e.g., 0.6 by default) may be removed from the training data set.

System 108 may additionally or alternatively screen the variables based on variance inflation factor (VIF) values (335). VIF values are used to quantify the severity of multicollinearity. In some embodiments, the VIF values may be calculated using a least square regression method. A customized cutoff VIF value (e.g., 10) may be used to filter out columns which are highly correlated with other columns.

Once the variables have been formatted and screened, a binary classification model may be fit onto the training data set (340). The conditioned data set may be split into two separate sets of data: a training data set used to generate the model, and a separate validation data set used to validate the model performance once it has been generated. A binary classification model may be fit onto the training data set. In some implementations, a logistic regression model may be used as the model for calculating the estimated likelihood of adoption. In some implementations, a random forest model may be used as the likelihood of adoption model. In still further implementations, other types of models may be used.

After the model is generated based on the training data set, the performance of the model may be tested using the validation data set (345). The validation data set may be provided as input to the model, and the output may be compared to the actual results associated with the validation data set and/or to a baseline performance level to determine whether the model performance is adequate. If the performance of the model under the validation data set is adequate, the model may be determined to be ready for use in evaluating opportunities for a customer. If the performance of the model is determined to be inadequate, the model may be further refined using additional/different training data. In some implementations, the performance of the model may be visually analyzed (e.g., by a user) by displaying the results as a receiver operating characteristic (ROC) curve or within lift and gain charts.

FIG. 3B illustrates a ROC curve chart 350 illustrating the performance of a model generated using process 300 based on an example data set according to an illustrative implementation. A ROC curve 355 associated with process 300 is shown along with ROC curves associated with other linear models under the same data set. It can be seen that, for this example data set, process 300 is among the two top performing models.

One common issue with linear models is overfitting, which occurs when the model selects variables incorrectly and describes noise instead of the underlying relationship between the model response and predictors. Such an issue is more likely to happen when the training data set has a large number of variables. One approach to control overfitting is to use regularization methods, such as L²-norm or Lasso, to explicitly penalize overly complex methods.

FIG. 3C illustrates a ROC curve chart 370 showing logit models of the training and 20% validation/control accounts associated with an example model creating using process 300 in comparison with the same associated with a L² regularized logit model according to an illustrative implementation. Curve 375 is associated with the training data set of the model created using process 300, and curve 380 is associated with the validation data set. Normally, the more overfitted model should have a wider gap between the training and validation curves. As can be seen in chart 370, the model created using process 300 is much less overfitted than the illustrated peer models.

Returning again to FIG. 2, in some implementations, content management system 108 may be configured to calculate a likelihood of marketing (215). A likelihood of marketing may be calculated in the event that the direct user of the recommendation tool is a customer service representative using the tool to determine opportunities to market to a customer. The likelihood of marketing may be calculated using a model such as a logistic regression model, a random forest model, or another type of model. In some implementations, the model may be generated using the same or a similar process as process 300 illustrated in FIG. 3A. The model may be generated and/or the likelihood of marketing may be calculated based on different input signals than the likelihood of adopting. For example, the input signals used with respect to the likelihood of marketing may include the revenue expected to be generated for the seller of the opportunities, a commission or other incentive that will be made by the customer service representative for selling the opportunity, quotas or other goal numbers associated with one or more of the opportunities, and/or other input factors that may affect the customer service representative's decision as to which opportunities will be present to the customer. In some implementations, signals similar to those used to calculate the likelihood of adoption may be used for the customer service representative or opportunity seller to calculate the likelihood of marketing.

Content management system 108 may calculate an expected revenue uplift for the customer for each opportunity based on one or more of the statistical models (220). The expected revenue uplift or increase may be an estimated increase in revenue for the customer that is expected to result from the customer adopting the opportunity. In various implementations, the model may be or include a logistic regression model, a random forest model, or another type of model configured to estimate the revenue increase associated with adopting the opportunity. The model may utilize various types of input to calculate the expected revenue increase, such as, for example, the recency, frequency, and/or trajectory of logins of content providers into system 108, the content provider's history of utilizing products/features of system 108 (e.g., conversion tracking, content extension, sitelink extension, video content, location extension, mobile or tablet, enhanced cost per click, conversion optimizer, etc.), content competitiveness metrics (e.g., impression shares, number/percent of content groups having relative click through rate, etc.), budget amount and utilization, average bid amount, performance statistics (e.g., number of impressions, click through rate, quality statistics, etc.), content provider trajectories (e.g., month or month spend growth, month over month cost per click, month or month click through rate, etc.), distribution over content types (e.g., percent of total content publication spend on display/mobile/search/video, etc.), number and type of content groups in which bids were submitted, number and type of keywords for which bids were submitted, number and status of campaigns in which bids were submitted, etc.

FIG. 4A illustrates a process 400 that may be used to generate the model used to calculate the expected revenue uplift according to an illustrative implementation. Like process 300, process 400 utilizes training data to build a predictive model as part of a training stage. Once the model has been built and validated, it may be used to predict the revenue/profit uplift that will be associated with adopting a particular opportunity.

System 108 may be configured to split (e.g., randomly) the treated and control data into a number of subgroups N (e.g., 6 by default) (405). In some implementations, the treated data may include accounts contacted (e.g., called/emailed) by the sales/service team and the control group may include accounts to which the sales/service team has not reached out during an experiment period.

System 108 may then build propensity score models in each group and score the accounts (410). Treatment selection bias may exist in the data, which may be caused by various factors. The existence of selection bias may harm a fair comparison between the treated (experimented) and control group. Propensity scores may be used to reduce or remove the selection bias. Propensity score models employ a predicted probability of group membership (e.g., treated vs. control group) based on observed predictors to create a counterfactual group. In some implementations, a random forest model may be used to build the propensity score model for matching the treatment and control groups. In some implementations, PScore models may be used, which are equivalent to propensity score.

The average propensity scores for each group i may be computed as follows:

score_{—}i=avg(score_{—}ij)over j
where i=1, . . . , N; j=1, . . . , N; i< > j and score_ij=group i's scores given by group j's model

Each account may be assigned into buckets based on its respective propensity score (415). In some implementations, all accounts may be split into a number of buckets (e.g., 10 by default) based on their propensity scores (e.g., the quantiles of the propensity scores). In each bucket, the control accounts' data is used to build a random forest model for predicting its pre/post-treatment (e.g., using a random treatment date assigned to each control account in order to obtain its pre/post treatment metric) differences of the performance metric. Once the models are created, the treated accounts' uplifts may be calculated (425). The treated accounts may be scored for their predicted pre-post difference of performance metric. The treated accounts' uplifts may be scored based on a difference between their actual pre-post differences and their predicted differences in each bucket.

System 108 may be configured to build a predictive model for calculating the expected revenue uplifts using the uplifts of the treated accounts (430). The candidate predictive input signals may be cleaned in a manner similar to that described with respect to process 300. Some transformations, such as binning, may be applied on some candidate signals. In some implementations, the transformation may include binning and/or log transform. The transformation may be designed to ensure that missing data, if more than a threshold value (e.g., 5%) of a column, is put into an individual bucket so its effect can be evaluated and that highly skewed variables can be adjusted (e.g., through log transformation). The data may be split into training and validation data sets, and the predictive model may be built on the training data set. In some implementations, the model may be a logistic regression model, a random forest model, or a different type of model. Once the model has been built onto the training data set, the validation data set may be used to validate the model performance and confirm whether or not adjustments to the model should be made. In some implementations, ROC curves and/or lift and gain charts may be used to compare the binarized uplift against the uplift scores. Once the model is validated and finalized, the model may be used to predict uplifts for new accounts (435). In some implementations, the new data may be cleaned and transformed using configuration files developed in the process of developing the model. The new data set may be scored for the predicted uplifts.

FIG. 4B illustrates an example ROC curve 450 illustrating the performance of an example predictive model generated using process 400 according to an illustrative implementation. When validating the performance of the model, the continuous response of revenue uplift may be transformed into a binary variable which takes the value of 1 if it is positive and 0 otherwise. ROC curve 450 is generated based on the binarized uplift data. Inspection of ROC curve 450 shows that the model has good performance with a 80% average true positive rate at the 40% average false positive rate. FIG. 4C provides a cumulative gains chart 470 showing the lift associated with the generated model.

Referring again to FIG. 2, once the likelihood of adoption and expected revenue uplift (and, in some implementations, likelihood of marketing) calculations have been performed, a final opportunity value may be calculated for each of the opportunities (225). In some implementations (e.g., if the direct users are customers), the raw opportunity values may be defined as:
opportunity value=likelihood of adoption x expected revenue uplift or, for implementations in which the opportunity value is further based on a likelihood of marketing (e.g., if the users are customer service representatives):
opportunity value=likelihood of marketing x likelihood of adoption x expected revenue uplift

Based on the opportunity values, the opportunities may be ranked at an account level. In some implementations, the accounts may be ranked within a program (e.g., a particular type of content publication program or product, such as search engine, mobile, video, etc.) and/or across multiple programs. For example, the opportunity values can be summed up for each account and their total may be used for account prioritization within a sales program or across a number of campaigns.

In some implementations, a linear programming model may be created to generate the final opportunity values and rank them for each account. In some implementations, the linear model may be configured to impose some constraints on the results. For example, opportunities may be excluded from consideration if the expected return on investment (ROI) (e.g., clicks) for the customers are decremented. In some implementations, a minimum and/or maximum number of opportunities to be presented to the user may be implemented by the linear model (e.g., a maximum of 5 and minimum of 3 opportunities). An example formulation of a linear programming model that may be used to provide recommendations to a customer service representative may be constructed as follows:

Indices:
c=campaign, cεC
i=content publisher/customer, iεI
j=opportunity (e.g., task or package), jεJ
p=phase, pεP

Data:
RU=revenue uplift
CU=clicks uplift
PP=probability of pitching/marketing
PA=probability of adoption
C=cost to opportunity seller
TU=upperbound limit of the number of recommended tasks
TL=lowerbound limit of the number of recommended tasks

Decision variable: x=recommendation action dummy variable

The model may be designed to identify opportunities that have the highest opportunity values, which are based on the probability of pitching PP, probability of adoption PA, and expected revenue uplift RU:

$$Maximize : u ( {x}_{i} ) = {\sum }_{c}^{C} {\sum }_{j}^{J} ( {x}_{c , i , j} {PP}_{c , i , j} {PA}_{c , i , j} {RU}_{c , i , j} )$$

In some implementations, one or more constraints may be placed on the model. For example, the variables may be forced to be binary in nature, such that x_{i,j}={0,1}. The model may be designed to only recommend opportunities that are profitable for the opportunity seller, such that the profit to the seller outweighs the cost associated with the opportunity:

$${\sum }_{c}^{C} {\sum }_{j}^{J} ( {x}_{c , i , j} {PP}_{c , i , j} {PA}_{c , i , j} {RU}_{c , i , j} ) \geq {\sum }_{j}^{J} {C}_{c , i , j}$$

The total number of recommendations may be constrained to be within a minimum and/or maximum number of recommendations:

$${\sum }_{c}^{C} {\sum }_{j}^{J} {x}_{c , i , j} \leq TU$$

$${\sum }_{c}^{C} {\sum }_{j}^{J} {x}_{c , i , j} \geq TL$$

In some implementations, opportunities may be constrained such that the total ROI or clicks for the customer is not decremented or increases by a threshold amount:

$${\sum }_{c}^{C} {\sum }_{j}^{J} ( {x}_{c , i , j} {PP}_{c , i , j} {PA}_{c , i , j} {RU}_{c , i , j} ) \geq 0 ( or - threshold )$$

Once the final opportunity values are calculated, one or more opportunities may be selected for presentation to the user (230). In some implementations, a set number or range of opportunities having the highest opportunity values may be selected for presentation. In some implementations, all opportunities having an opportunity value above a certain threshold may be presented. In some implementations, a set number or range of opportunities having the highest opportunity values may be presented, but only if the opportunities have an opportunity value above a certain threshold value. In some implementations, hard eligibility filters may be applied and may restrict or eliminate one or more of the opportunities from consideration. For example, opportunities associated with certain content publication programs may require that the customer have not registered with the program within a threshold amount of time prior to the opportunity (e.g., as part of a promotional opportunity to encourage the customer to register with the program).

System 108 may provide the user with information relating to the selected opportunities (235). In some implementations, the opportunity value and/or the component signals and/or calculated values (e.g., likelihood of marketing/adoption and expected revenue uplift) may be converted into a format (e.g., a textual format) that may be interpreted by the user for the purposes of evaluating the opportunities. In some implementations, the opportunity value and/or expected revenue uplift may be represented as a monetary value (e.g., expected increase in revenue/impact over a particular time period associated with adopting the opportunity).

In some implementations, the information presented to the user may be based in part on one or more “soft” filters that are based on selected signal and/or weights from the statistical prediction models used in calculating the opportunity value. The output of the models may include a list of signals and their weights from the coefficients of the prediction models. Example signals that may be included as part of the soft filters may include, for example, whether the customer is registered with and/or actively using a particular content publication program, how much of a budget was spent on a particular program, whether a campaign budget has increased, a number of content items created within a certain recent time period, a budget amount for the account, a time period since the customer last logged in with system 108, and/or various other types of signal. In some implementations, selected upsell signals may be provided that are personalized to each opportunity. In some implementations, the number of upsell signals presented to a customer service representative may be limited (e.g., maximum of 10) to avoid overwhelming the representative with too much information. The signals may be selected from the prediction models (e.g., opportunity value and/or likelihood of adoption and their confidence intervals) or from recommendations of a collaborating program manager (e.g., budget utilization and/or logins).

In some implementations, the opportunities may be packaged and recommended within the packages. For example, the opportunities may be packaged based on their affinity, adoption sequence, aggregated revenue impact, etc. The opportunities may be recommended based on their aggregated opportunity values. In some implementations, the opportunities may be clustered based on granular change history at the campaign or content group level.

In some implementations, some new services/products may not have enough history relating to the services to provide meaningful recommendations based solely on the history of those services. In such implementations, sibling services/products may be identified as having the closest relation to the services being analyzed, and the recommendations may be provided based on historical data associated with those sibling services.

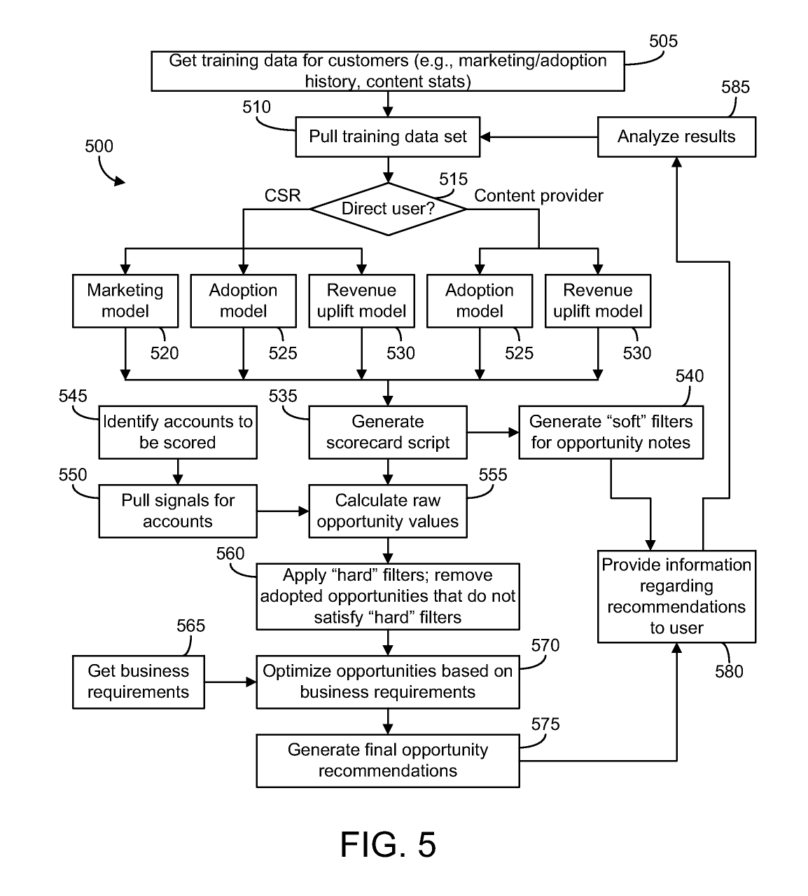

Referring now to FIG. 5, a flow diagram of a process 500 is shown according to an illustrative implementation. Process 500 is a more detailed illustrative implementation of process 200. Process 500 is implemented using two main stages, training (including validation) and scoring. In the training phase, process 500 takes input (e.g., pitching/marketing and/or adoption history) and generates an output of an opportunity scoring script. Once the models have been developed using the training data, new data may be input and used to generate recommendations for opportunities. In some implementations, the opportunity information may be presented to a customer service representative. In some implementations, the opportunity information may be presented directly to the content provider customers.

System 108 may be configured to obtain a data set 505 to be used in training and validation of the models used to determine the opportunity values (510). Data set 505 may include data relating to a marketing history of the customer service representative, adoption history of the customer, and/or various statistics relating to the customer and/or content being analyzed. System 108 may determine whether the direct user is a customer service representative (CSR) or a content provider (515). If the direct user is a content provider, the training data may be used to generate a likelihood of adoption model 525 and a revenue uplift model 530. If the direct user is a CSR, the training data may also be used to generate a likelihood of marketing model 520.

In some implementations, after the models are built, the model coefficients may be parsed and written into a scorecard script such as a large tenzing/dremel query (535). The scorecard script may be run on updated signals for new accounts to generate the predicted likelihood and revenue uplift values and a raw opportunity value (e.g., at a dimension of account x opportunity). In some implementations, the scorecard script may be used to generate one or more “soft” filters for providing opportunity notes to the user (540).

Once the models are generated, opportunities associated with new data/accounts can be scored in a scoring phase. The new accounts to be scored may be identified (545) and the relevant signals associated with those accounts may be obtained by system 108 (550). The predicted likelihood and revenue uplift values and the raw opportunity values may be generated for each opportunity, for example, using the scorecard script (555).

To generate the final opportunity values and recommendations, the opportunities may be processed through a model designed to maximize revenue uplift while applying constraints to the opportunities to be presented. One or more “hard” filters may be applied to the data, and opportunities that do not satisfy the hard filters may be removed from the opportunities that may be presented to the user (560). System 108 may obtain business requirements (565) to be applied to the opportunities (e.g., maximum or minimum number of opportunities to be presented, requirement that opportunities do not reduce ROI or clicks for customer, requirement that opportunity costs do not exceed profits for seller, etc.) and may optimize or constrain the opportunities based on the business requirements (570). System 108 may then generate the final opportunity recommendations (575) and the information regarding the recommendations may be presented to the user (580). In some implementations, one or more information items relating to the soft filters may be presented as well. In some implementations, the outcome of the recommendations (whether or not the user adopted the opportunities) may be analyzed and used to refine the models to improve future recommendations provided by system 108 (585). In some implementations, the refinements may be made automatically in a self-learning and/or self-evaluating manner without further intervention by the user.

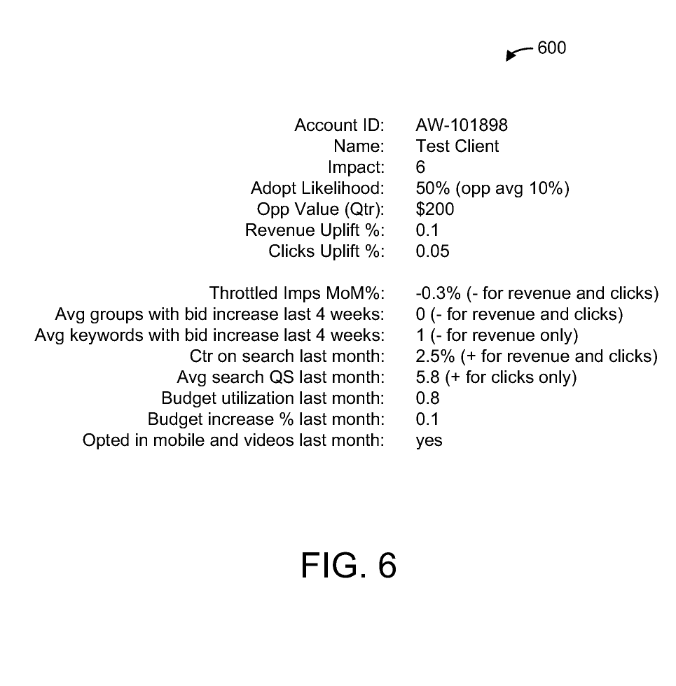

Referring now to FIG. 6, a display image 600 that shows example final opportunity recommendation information that may be presented to a user is shown according to an illustrative implementation. Image 600 includes an identifier for the account and a name of the customer. Image 600 also includes an adoption likelihood value presented as a percentage along with an average adoption likelihood value associated with the analyzed opportunities. Image 600 includes a revenue uplift and clicks uplift value, each represented by an expected percentage increase in revenue/clicks. Image 600 includes a final opportunity value, which is represented in the example as a monetary value associated with the opportunity over a financial quarter.

Image 600 also includes some selected “soft” filters or signals used in determining the opportunity value. In the illustrated example, image 600 displays a percentage decrease in throttled impressions month-over-month, an average number of content publication groups with a bid increase in the last four weeks, an average number of keywords with a bid increase in the last four weeks, a click through rate on content published in relation to a search engine over the last month, an average quality score associated with the search-related content over the last month, a budget utilization value for the last month, a percentage increase in budget over the last month, and an indicator of whether or not the customer has opted into mobile and/or video-based content publication programs over the last month. It should be understood that the information presented in image 600 is merely illustrative, and, in other implementations, various other types of signals, data, and/or other information may be presented to the user.

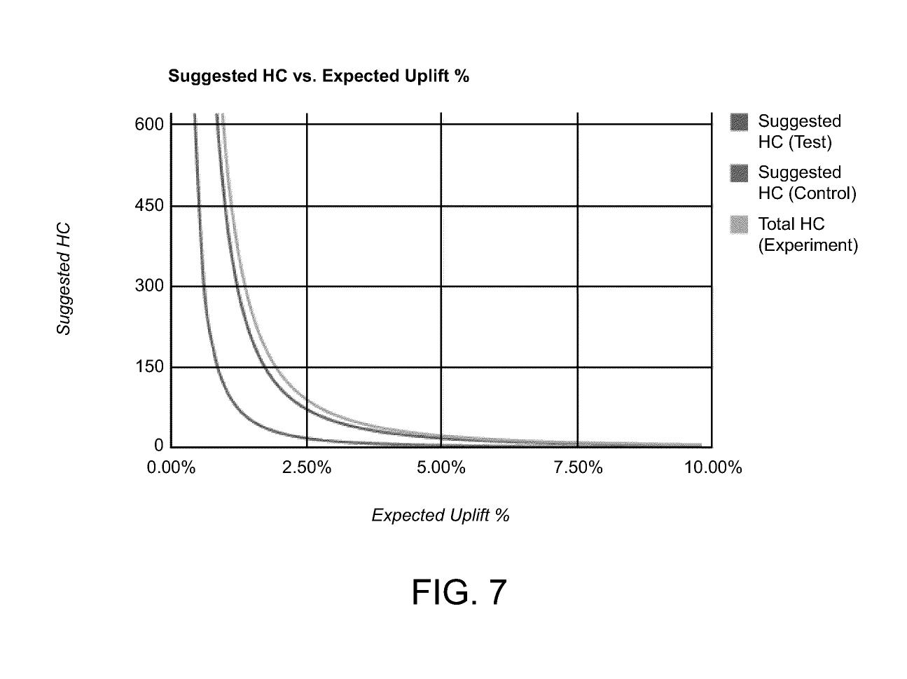

It may be challenging to find a clean control or treated group to estimate the impact of the methods and systems described herein on evaluating available opportunities. One method of solving this issue is to utilize a random experiment approach to evaluate the impact. Determining the minimum sample account size, or headcount, for the experiments and re-setting the performance targets of the users are the main issues in the random experiment approach. A statistical tool for estimating the experiment headcount may be developed where users can make assumptions and look up the suggested headcount. An example look-up chart 700 for suggested headcount is provided in FIG. 7 according to an illustrative implementation. In some implementations, advanced users may be provided with an interface to access functions for training, validating, and/or scoring opportunities using a number of statistical and/or machine learning models (e.g., logistic regression, random forest, support vector machine, etc.). In some implementations, the training and scoring processes may be automated and implemented in R and dremel/tenzing queries. In some such implementations, the users may be allowed to access, monitor, and/or modify aspects of the queries and/or apply their own prediction models on the training data set to compare the performance.

In some implementations, the recommendation model may be built at a geo-vertical level or a hierarchical level. In some implementations, the capacity of the models may be extended by calling efficient packages (e.g., C++, Java, etc.), such as Seti, Weka, etc. In some implementations, regularization methods and model averaging methods (e.g., bagging or boosting) may be used to improve the opportunity explanations and/or recommendations.

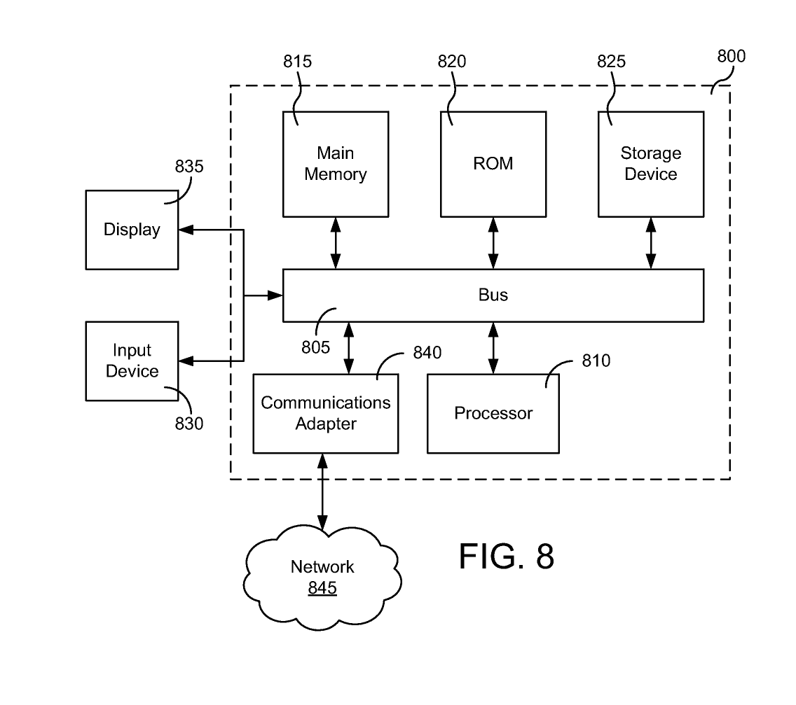

FIG. 8 illustrates a computer system 800 that can be used, for example, to implement an illustrative user device 104, customer service representative (CSR) device 105, an illustrative content management system 108, an illustrative content provider device 106, and/or various other illustrative devices and/or systems that may be used in the implementation of an environment in which online content may be published as described in the present disclosure. The computing system 800 includes a bus 805 or other communication component for communicating information and a processor 810 coupled to the bus 805 for processing information. The computing system 800 also includes main memory 815, such as a random access memory (RAM) or other dynamic storage device, coupled to the bus 805 for storing information, and instructions to be executed by the processor 810. Main memory 815 can also be used for storing position information, temporary variables, or other intermediate information during execution of instructions by the processor 810. The computing system 800 may further include a read only memory (ROM) 810 or other static storage device coupled to the bus 805 for storing static information and instructions for the processor 810. A storage device 825, such as a solid state device, magnetic disk or optical disk, is coupled to the bus 805 for persistently storing information and instructions.

The computing system 800 may be coupled via the bus 805 to a display 835, such as a liquid crystal display, or active matrix display, for displaying information to a user. An input device 830, such as a keyboard including alphanumeric and other keys, may be coupled to the bus 805 for communicating information, and command selections to the processor 810. In another implementation, the input device 830 has a touch screen display 835. The input device 830 can include a cursor control, such as a mouse, a trackball, or cursor direction keys, for communicating direction information and command selections to the processor 810 and for controlling cursor movement on the display 835.

In some implementations, the computing system 800 may include a communications adapter 840, such as a networking adapter. Communications adapter 840 may be coupled to bus 805 and may be configured to enable communications with a computing or communications network 845 and/or other computing systems. In various illustrative implementations, any type of networking configuration may be achieved using communications adapter 840, such as wired (e.g., via Ethernet), wireless (e.g., via WiFi, Bluetooth, etc.), pre-configured, ad-hoc, LAN, WAN, etc.

According to various implementations, the processes that effectuate illustrative implementations that are described herein can be achieved by the computing system 800 in response to the processor 810 executing an arrangement of instructions contained in main memory 815. Such instructions can be read into main memory 815 from another computer-readable medium, such as the storage device 825. Execution of the arrangement of instructions contained in main memory 815 causes the computing system 800 to perform the illustrative processes described herein. One or more processors in a multi-processing arrangement may also be employed to execute the instructions contained in main memory 815. In alternative implementations, hard-wired circuitry may be used in place of or in combination with software instructions to implement illustrative implementations. Thus, implementations are not limited to any specific combination of hardware circuitry and software.

Although an example processing system has been described in FIG. 8, implementations of the subject matter and the functional operations described in this specification can be carried out using other types of digital electronic circuitry, or in computer software, firmware, or hardware, including the structures disclosed in this specification and their structural equivalents, or in combinations of one or more of them.

Implementations of the subject matter and the operations described in this specification can be carried out using digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be implemented as operations performed by a data processing apparatus on data stored on one or more computer-readable storage devices or received from other sources.

The term “data processing apparatus” or “computing device” encompasses all kinds of apparatus, devices, and machines for processing data, including by way of example, a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be carried out using a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be carried out using a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

In some illustrative implementations, the features disclosed herein may be implemented on a smart television module (or connected television module, hybrid television module, etc.), which may include a processing circuit configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services (e.g., Netflix, Vudu, Hulu, etc.), a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate implementations, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be carried out in combination or in a single implementation. Conversely, various features that are described in the context of a single implementation can also be carried out in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Additionally, features described with respect to particular headings may be utilized with respect to and/or in combination with illustrative implementations described under other headings; headings, where provided, are included solely for the purpose of readability and should not be construed as limiting any features provided with respect to such headings.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products embodied on tangible media.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
receiving, at a computerized recommendation system, input data relating to a plurality of service options for one or more services provided to a customer using a communications network, wherein the input data includes training data;
generating one or more statistical models based on the training data and storing the one or more statistical models in a memory;
for each of the plurality of service options:
calculating, at the recommendation system using the one or more statistical models stored in the memory, an estimated likelihood of adoption, wherein the estimated likelihood of adoption is an estimate of the probability that the customer will adopt the service option;
calculating, at the recommendation system using the one or more statistical models stored in the memory, an expected revenue increase, wherein the expected revenue increase is an estimated increase in revenue for the customer that is expected to result from the customer adopting the service option;
calculating, at the recommendation system, an opportunity score for the service option based on the estimated likelihood of adoption and the expected revenue increase;
selecting, at the recommendation system, one or more of the service options to be recommended to a user based on the opportunity scores of the plurality of service options; and
providing the user with information relating to the one or more selected service options.

2. The method of claim 1, wherein the user is an individual who markets service options to the customer, wherein the method further comprises, for each of the plurality of service options, calculating, at the recommendation system using the one or more statistical models stored in the memory, an estimated likelihood of marketing, wherein the estimated likelihood of marketing is an estimate of the probability that the user will select the service option for recommendation to the customer, and wherein the opportunity score is calculated further based on the estimated likelihood of marketing.

3. The method of claim 1, wherein the one or more statistical models comprise at least one of a logistic regression model and a random forest model, and wherein calculating the estimated likelihood of adoption comprises applying the at least one of the logistic regression model and the random forest model to the input data.

4. The method of claim 1, wherein the one or more statistical models comprise at least one of a logistic regression model and a random forest model, and wherein calculating the expected revenue increase comprises applying the at least one of the logistic regression model and the random forest model to the input data.

5. The method of claim 1, further comprising:
receiving one or more parameters from the user for the service options to be recommended; and
selecting the one or more service options to be recommended to the user further based on the one or more parameters received from the user.

6. The method of claim 5, wherein the one or more parameters comprise a maximum number of service options to be recommended by the recommendation system.

7. The method of claim 5, wherein the one or more parameters comprise a constraint that any service options selected for recommendation must maintain or increase a current expected return on investment for the customer.

8. The method of claim 1, wherein providing the user with information relating to the one or more selected service options comprises converting at least one of the opportunity score and output signals generated by the one or more statistical models into notes that are interpretable by the user.

9. The method of claim 8, wherein converting at least one of the opportunity score and output signals generated by the one or more statistical models into notes that are interpretable by the user comprises representing the opportunity score to the user in the form of a monetary value.

10. A system comprising:
at least one computing device operably coupled to at least one memory and configured to:
receive input data relating to a plurality of service options for one or more services provided to a customer using a communications network, wherein the input data includes training data;
generate one or more statistical models based on the training data and storing the one or more statistical models in a memory;
for each of the plurality of service options:
calculate, using the one or more statistical models, an estimated likelihood of adoption, wherein the estimated likelihood of adoption is an estimate of the probability that the customer will adopt the service option;
calculate, using the one or more statistical models, an expected revenue increase, wherein the expected revenue increase is an estimated increase in revenue for the customer that is expected to result from the customer adopting the service option;
calculate an opportunity score for the service option based on the estimated likelihood of adoption and the expected revenue increase;
select one or more of the service options to be recommended to a user based on the opportunity scores of the plurality of service options; and
provide the user with information relating to the one or more selected service options.

11. The system of claim 10, wherein the user is an individual who markets service options to the customer, wherein the at least one computing device is further configured to, for each of the plurality of service options, calculate, using the one or more statistical models, an estimated likelihood of marketing, wherein the estimated likelihood of marketing is an estimate of the probability that the user will select the service option for recommendation to the customer, and wherein the opportunity score is calculated further based on the estimated likelihood of marketing.

12. The system of claim 10, wherein the one or more statistical models comprise at least one of a logistic regression model and a random forest model, and wherein the at least one computing device is configured to apply the at least one of the logistic regression model and the random forest model to the input data to calculate the estimated likelihood of adoption.

13. The system of claim 10, wherein the one or more statistical models comprise at least one of a logistic regression model and a random forest model, and wherein the at least one computing device is configured to apply the at least one of the logistic regression model and the random forest model to the input data to calculate the expected revenue increase.

14. The system of claim 10, wherein the at least one computing device is further configured to:
receive one or more parameters from the user for the service options to be recommended; and
select the one or more service options to be recommended to the user further based on the one or more parameters received from the user.

15. The system of claim 14, wherein the one or more parameters comprise a maximum number of service options to be recommended by the recommendation system.

16. The system of claim 15, wherein the one or more parameters comprise a constraint that any service options selected for recommendation must maintain or increase a current expected return on investment for the customer.

17. The system of claim 10, wherein the at least one computing device is configured to convert at least one of the opportunity score and output signals generated by statistical models used by the at least one computing device into notes that are interpretable by the user.

18. The system of claim 17, wherein the at least one computing device is configured to represent the opportunity score to the user in the form of a monetary value.

19. A computer-readable storage medium having instructions stored thereon that, when executed by a processor, cause the processor to perform operations comprising:
receiving input data relating to a plurality of service options for one or more services provided to a customer using a communications network, wherein the input data includes training data;
generating one or more statistical models based on the training data and storing the one or more statistical models in a memory;
for each of the plurality of service options:
calculating, using the one or more statistical models stored in the memory, an estimated likelihood of adoption, wherein the estimated likelihood of adoption is an estimate of the probability that the customer will adopt the service option;
calculating, using the one or more statistical models stored in the memory, an expected revenue increase, wherein the expected revenue increase is an estimated increase in revenue for the customer that is expected to result from the customer adopting the service option;
calculating an opportunity score for the service option based on the estimated likelihood of adoption and the expected revenue increase;
selecting one or more of the service options to be recommended to a user based on the opportunity scores of the plurality of service options; and
providing the user with information relating to the one or more selected service options.

20. The computer-readable storage medium of claim 19, wherein the user is an individual who markets service options to the customer, wherein the operations further comprise, for each of the plurality of service options, calculating, using the one or more statistical models stored in the memory, an estimated likelihood of marketing, wherein the estimated likelihood of marketing is an estimate of the probability that the user will select the service option for recommendation to the customer, and wherein the opportunity score is calculated further based on the estimated likelihood of marketing.

21. The computer-readable storage medium of claim 19, wherein the operations further comprise:
receiving one or more parameters from the user for the service options to be recommended; and
selecting the one or more service options to be recommended to the user further based on the one or more parameters received from the user.

22. The computer-readable storage medium of claim 19, wherein providing the user with information relating to the one or more selected service options comprises converting at least one of the opportunity score and output signals generated by statistical models into notes that are interpretable by the user.
